(19) United States
(12) Patent Application Publication
(10) Pub. No.: US 2025/0167272 A1
(43) Pub. Date: May 22, 2025

(54) SYSTEMS AND METHODS FOR PRESSURIZING HYDROGEN USED IN PROTON EXCHANGE MEMBRANE FUEL CELLS

(71) Applicant: CATERPILLAR INC.,, Peoria, IL (US)

(72) Inventors: Benjamin William HANKS, East Peoria, IL (US); WILLIAM CHRISTOPHER BOLEY, Dunlap, IL (US); DAVID M. GINTER, Peoria, IL (US)

(73) Assignee: CATERPILLAR INC.,, Peoria, IL (US)

(21) Appl. No.: 18/511,520

(22) Filed: Nov. 16, 2023

(51) Int. Cl. H01M 8/0612; B01D 53/22; C01B 3/32; C01B 3/50; H01M 8/04111; H01M 8/04746; H01M 8/04992; H01M 8/10

(52) U.S. Cl. CPC H01M 8/0618; B01D 53/22; C01B 3/323; C01B 3/501; H01M 8/04111; H01M 8/04753; H01M 8/04992; B01D 2256/16; B01D 2257/504; C01B 2203/0233; C01B 2203/0244; C01B 2203/041; C01B 2203/0475; C01B 2203/067; C01B 2203/1076; C01B 2203/1223; C01B 2203/84; H01M 2008/1095

(57) ABSTRACT

A fuel cell electrical power generation system is described herein. The system uses the pressure of a raffinate stream to compress hydrogen separated from the raffinate stream used for PEM fuel cells. A reformer, such as a methanol steam reformer, is used to generate a gases stream including hydrogen. The hydrogen is separated from other products of the reformer. To increase the pressure of the hydrogen for use in a PEM fuel cell, the raffinate is expanded in a turbocharger. The expansion of the relatively higher raffinate stream is used to operate a compressor that compresses the relatively lower hydrogen. The compressed hydrogen is used as a hydrogen input for the PEM fuel cell.

### TECHNICAL FIELD

The present disclosure relates to electrical power generation systems. More specifically, the present disclosure relates to using fluidic pressure from a reformer to pressurize hydrogen gas used in proton exchange membrane cells.

### BACKGROUND

As industries electrify, i.e., increasingly use electric-powered equipment and machines, traditional sources of power such as mechanical combustion engines and turbines are being replaced with alternative power generation systems. An example of an alternative power generation system is a hydrogen fuel cell. Fuel cells that use hydrogen and oxygen, or other chemical combinations, to generate electricity via electrochemical reactions can provide significant advantages as power sources over conventional diesel or gas generator sets. For example, fuel cells provide a clean energy source with a smaller carbon footprint. Fuel cells are also longer-lasting, quieter, and more reliable as a backup energy source, as compared with comparable generator sets.

A common type of hydrogen fuel cell technology is the proton exchange membrane (PEM) fuel cell. Generally, in PEM fuel cells, hydrogen fuel is channeled or ported into field flow plates on an anode side, while oxygen (from air) is channeled or ported to the cathode side, which is on the other side of a fuel cell. A catalyst (typically platinum or platinum-based) on the anode side causes the hydrogen to split into positive hydrogen ions (the proton) and negatively charged electrons. The polymer electric membrane between the anode and the cathode allows the protons to pass through it, while forcing the electrons to travel through an electrical circuit to the cathode. This creates an electrical current. At the cathode, the electrons and the protons combine with oxygen to form water, which flows out of the cell. Adding PEM fuel cells (or stacks) increases the voltage available. The hydrogen used in PEM fuel cells is sometimes provided at an elevated pressure to increase the efficiency of the PEM fuel cell.

Some attempts have been made to use waste energy created in the process of using a PEM fuel cell (in the form of pressure or temperature) to increase the efficiency of a PEM fuel cell system. For example, one approach to this is described in U.S. Pat. No. 7,097,925 to Keefer (“the '925 patent”). The '925 patent describes a system that separates hydrogen from an anode exhaust and recycle that hydrogen for use by the fuel cell. Further, the '925 patent describes the use of an energy recovery system to recovery energy from exhaust gases to power mechanical loads associated with a gas separation system. For example, the exhaust gases can be used to recompress hydrogen recovered in the anode exhaust. However, the technologies described in the '925 can be limited and may have some disadvantages. For example, the systems of the '925 require that the exhaust gases be of sufficient pressure to power the energy recovery portions of the system. However, in some conditions, the pressure of the exhaust gases may be too low to provide sufficient energy to do so. Thus, the ability to recompress the recovered hydrogen depends on exhaust gas pressure, and in some high load conditions, the pressure may not be sufficient to recompress the hydrogen at a pressure needed to sustain the system. In another example, energy from the hydrogen production process itself is not used, thus resulting in a potential loss of energy that may be used to provide various functions such as hydrogen compression.

Examples of the present disclosure are directed to overcoming deficiencies of such systems.

### SUMMARY

In one aspect of the presently disclosed subject matter, a hydrogen production unit includes a reformer for reforming a hydrocarbon to produce an output stream comprising hydrogen and a plurality of secondary outputs, a separator for separating the output stream into a raffinate stream at a first pressure and at least a portion of the hydrogen at a second pressure, wherein the second pressure is lower than the first pressure, and a turbocharger comprising: a turbine expander for receiving the raffinate stream at the first pressure and exhausting the raffinate stream at a third pressure, wherein the third pressure is lower than the first pressure, wherein an expansion of the raffinate stream rotates a shaft rotationally connected to the turbine expander, and a compressor for receiving the portion of the hydrogen at the second pressure and compressing the portion of the hydrogen to a fourth pressure, wherein the compressor is rotationally connected to the shaft.

In another aspect of the presently disclosed subject matter, a fuel cell system includes a proton exchange membrane (PEM) fuel cell configured to receive hydrogen and air to produce electrical power for an electrical load, a hydrogen production unit for producing the hydrogen, the hydrogen production unit comprising a reformer for reforming a hydrocarbon to produce an output stream comprising the hydrogen and a plurality of secondary outputs, a separator for separating the output stream into a raffinate stream at a first pressure and at least a portion of the hydrogen at a second pressure, wherein the second pressure is lower than the first pressure, and a turbocharger comprising a turbine expander for receiving the raffinate stream at the first pressure and exhausting the raffinate stream at a third pressure, wherein the third pressure is lower than the first pressure, wherein an expansion of the raffinate stream rotates a shaft rotationally connected to the turbine expander, and a compressor for receiving the portion of the hydrogen at the second pressure and compressing the portion of the hydrogen to a fourth pressure, wherein the compressor is rotationally connected to the shaft.

In a still further aspect of the presently disclosed subject matter, a method of operating a fuel cell system includes reforming a hydrocarbon to produce a reformer output comprising hydrogen and a plurality of secondary outputs, separating the reformer output into a hydrogen stream at a first pressure and a raffinate stream at a second pressure, directing the hydrogen stream into a compressor of a turbocharger to compress the hydrogen stream from the first pressure to a third pressure, wherein the third pressure is higher than the first pressure, and directing the raffinate stream into a turbine expander of the turbocharger, wherein an expansion of the raffinate stream in the turbine expander powers the compressor to compress the hydrogen stream from the first pressure to a third pressure.

### BRIEF DESCRIPTION OF DRAWINGS

FIG. 1 illustrates a hydrogen production unit, in accordance with one or more examples of the present disclosure.

FIG. 2 illustrates a fuel cell system using a hydrogen production unit, in accordance with one or more examples of the presently disclosed subject matter.

FIG. 3 illustrates a method for operating a fuel cell system, in accordance with one or more examples of the present disclosure.

FIG. 4 depicts a component level view of a controller for controlling a fuel cell system, in accordance with one or more examples of the present disclosure.

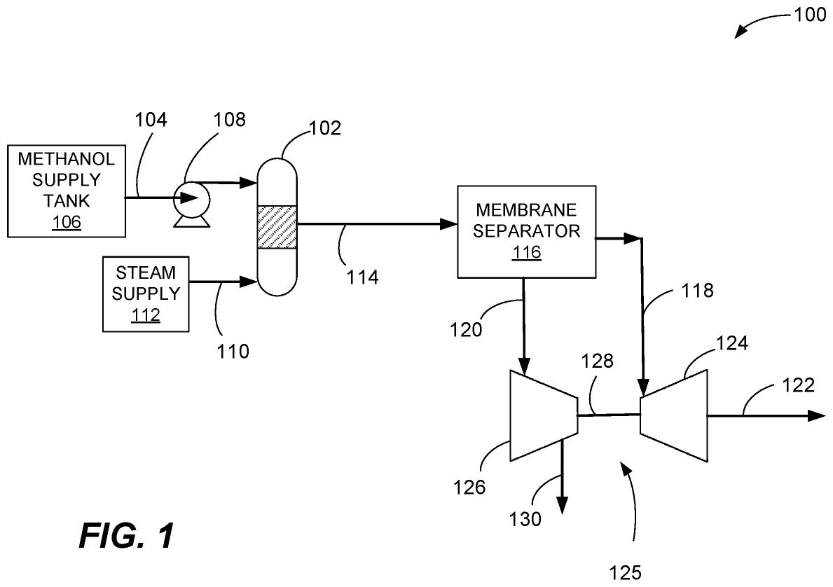

### DETAILED DESCRIPTION

Wherever possible, the same reference numbers will be used throughout the drawings to refer to the same or like parts. FIG. 1 illustrates a hydrogen production unit 100, in accordance with one or more examples of the present disclosure. The hydrogen production unit 100 includes a reformer 102. It should be noted that, although the presently disclosed subject matter is described as using a particular reformer feedstock (methanol) provided as an input to the reformer 102, other feedstocks (hydrocarbons) may be used and are considered to be within the scope of the presently disclosed subject matter. The other feedstocks for the reformer 102 that may be used include, but are not limited to, natural gas (methane), light hydrocarbons, and oxygenated hydrocarbons. Further, other technologies may be used to produce hydrogen using a separator including, but not limited to, partial oxidation and autothermal reforming. The reformer 102 receives as an input methanol 104 from a methanol supply tank 106. The methanol 104 is pumped from the methanol supply tank 106 using a methanol pump 108 that is in fluidic communication with the methanol supply tank 106 and the reformer 102. It should be noted that in some examples, the methanol pump 108 may not be used, including in examples where the methanol supply tank 106 is at a pressure to provide a sufficient fluidic pressure to the methanol 104 to move the methanol 104 from the methanol supply tank 106 to the reformer 102. The reformer 102 further receives steam 110 from a steam supply 112. Chemical reactions in the reformer 102 react generally according to the following reactions:

CH3OH(g)+H2O(g)=CO2+3H2 (1)

CO+H2O=CO2+H2 (2)

CO+H2O=CO2+H2 (3)

CH3OH(g)=CO+2H2 (4)

Although various catalysts may be used, in some examples, the reformer 102 may use copper-based catalysts, but other catalysts may be used, including, but not limited to, Group 8-10 catalysts. The presently disclosed subject matter is not limited to the use of a steam reformer or a particular alloy used in the reformer. Reaction (1) is the primary methanol steam reforming reaction. Reaction (2) is a water gas shift reaction. Reaction (3) is a methanol decomposition reaction. A reformer output 114 may thus be comprised of hydrogen (H) and one or more secondary outputs such as, but not limited to, carbon dioxide (CO2), carbon monoxide (CO), and water (H2O).

The reformer output 114 enters a membrane separator 116 in some examples at a pressure in a range between 200 PSIG and 300 PSIG. The membrane separator 116 may be a type of membrane reactor that uses a membrane separation process to separate at least a portion of hydrogen in the reformer output 114 from the rest of the constituent components of the reformer output 114. The presently disclosed subject matter is not limited to the use of a membrane separator, as other types of separators may be used including, but not limited to, water gas shift separators, pressure swing adsorption separators, and partial oxidation separators. The membrane separator 116 provides two outputs: a hydrogen stream 118 that is comprised of highly purified hydrogen; and a raffinate stream 120 that is comprised of the remaining constituent components of the reformer output 114 that were not separated into the hydrogen stream 118 in the membrane separator 116.

In some examples, the pressure of the raffinate stream 120 may be approximately in the range of 200-300 PSIG, and generally in the range of 260-280 PSIG. In further examples, the pressure of the hydrogen stream 118 may be in the range of 2-15 PSIG, and generally in the range of 8-12 PSIG. It should be noted that the presently disclosed subject matter is not limited to this particular range of pressures, as some systems may have higher pressures, and some may have lower pressures. Returning to FIG. 1, when used in conjunction with a proton exchange membrane (PEM) fuel cell, it may be desirable for the pressure of the hydrogen stream 118 to be at a higher pressure than the pressure of the hydrogen stream 118, such as above a range from 25 PSIG-90 PSIG. It should be noted that the presently disclosed subject matter is not limited to any particular range of pressure increase or pressure.

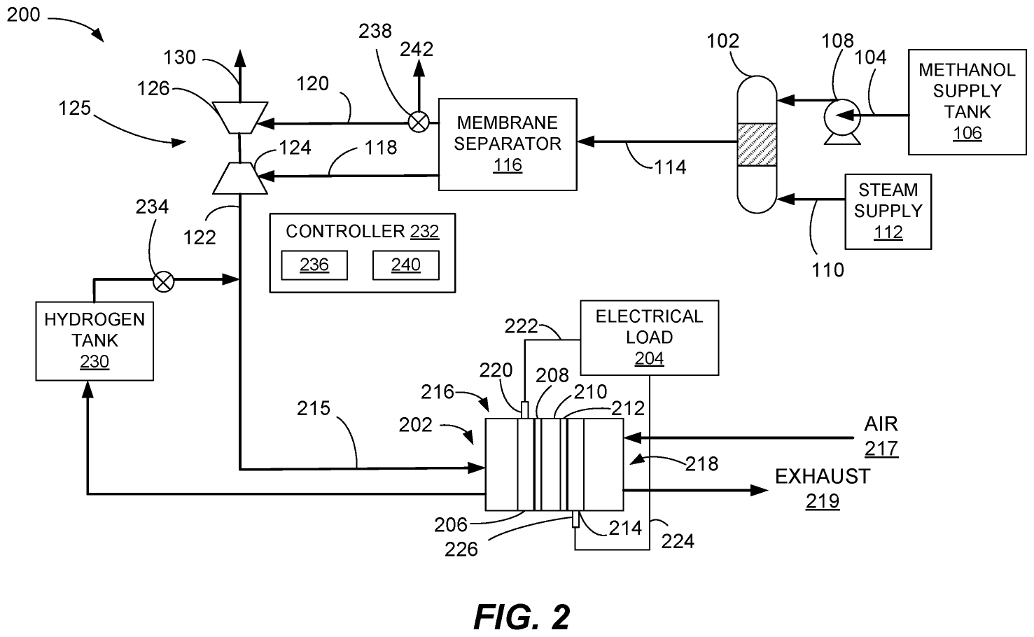

To increase the pressure of the hydrogen stream 118 to a hydrogen source stream 122 at a higher pressure, a turbocharger 125 is provided. The turbocharger 125 uses the higher pressure raffinate stream 120 to compress the relatively lower pressure hydrogen stream 118. At a higher pressure, the hydrogen source stream 122 can be used, in some examples, for a PEM fuel cell (described in more detail in FIG. 2, below). The hydrogen stream 118 is in fluidic communication with and enters a compressor 124. The compressor 124 compresses the hydrogen stream 118 to provide the hydrogen source stream 122. To provide rotational power to blades (not shown) of the compressor 124, the compressor 124 is mechanically and rotationally connected to a turbine expander 126 via a shaft 128.

The relatively higher pressure raffinate stream 120 enters the turbine expander 126 of the turbocharger 125. The raffinate stream 120 is allowed to expand in the turbine expander 126, causing internal blades (not shown) of the turbine expander 126 to rotate. The rotation of the internal blades of the turbine expander 126 rotate the shaft 128 that is mechanically connected to the turbine expander 126 and the compressor 124, whereby the shaft 128 rotationally connects the blades of the turbine expander 126 to the blades of the compressor 124. The rotation of the shaft 128 rotates the blades of the compressor 124, compressing the hydrogen stream 118 into the hydrogen source stream 122. The expanded raffinate stream 120 exits the turbine expander 126 as a relatively lower pressure raffinate output 130. The hydrogen source stream 122 can be used to power a PEM fuel cell, an example of which is provided in FIG. 2.

FIG. 2 is an illustration of a PEM fuel cell system 200 that uses the hydrogen production unit 100 of FIG. 1 as a source of hydrogen, in accordance with various examples of the presently disclosed subject matter. As described above, the hydrogen production unit 100 includes a reformer 102 which receives the methanol 104 from the methanol supply tank 106 using a methanol pump 108. The reformer 102 further receives the steam 110 from the steam supply 112. In a chemical reaction, the reformer output 114 is produced. The reformer output 114, comprises mainly of hydrogen (H), carbon dioxide (CO2), carbon monoxide (CO), and water (H2O), enters the membrane separator 116. The membrane separator 116 provides the two outputs: the hydrogen stream 118 and the raffinate stream 120, with the raffinate stream 120 at a higher pressure than the hydrogen stream 118.

To increase the pressure of the hydrogen stream 118, the turbocharger 125 is used. The turbocharger 125 uses the higher pressure raffinate stream 120 to compress the relatively lower pressure hydrogen stream 118. The rotation of the internal blades of the turbine expander 126 caused by the expansion of the raffinate stream 120 rotates the shaft 128, which in turn rotates the blades of the compressor 124, compressing the hydrogen stream 118 into the hydrogen source stream 122. The expanded raffinate stream 120 exits the turbine expander 126 as a relatively lower pressure raffinate output 130.

The hydrogen source stream 122 can be used to power one or more PEM fuel cells, such as a PEM fuel cell 202. The fuel cell 202 can be used to produce electrical power for an electrical load 204. The electrical load 204 can be one or more components powered by electricity such as, but not limited to, motors for moving a vehicle, computers, air conditioners, screens, and the like. The presently disclosed subject matter is not limited to any particular type of electrical load 204. The fuel cell 202 has an anode gas diffusion layer 206, an anode catalyst 208, a proton exchange membrane 210, a cathode catalyst 212, and a cathode gas diffusion layer 214. The anode gas diffusion layer 206 and the cathode gas diffusion layer 214 are permeable materials that are typically made of carbon fibers. The anode gas diffusion layer 206 and the cathode gas diffusion layer 214 facilitate the diffusion of a hydrogen supply 215, on an anode side 216, and air 217 (oxygen) on a cathode side 218 towards their respective catalysts. The anode catalyst 208 and the cathode catalyst 212 are typically constructed of precious metals such as platinum or platinum alloys such as platinum-ruthenium. The anode catalyst 208 and the cathode catalyst 212 accelerate chemical reactions on both the anode side 216 and the cathode side 218, respectively. The resulting exhaust 219 (typically water or water vapor) is output from the fuel cell 202.

The proton exchange membrane 210 allows hydrogen ions (the protons) created on the anode side 216 to permeate through the proton exchange membrane 210 while blocking electrons, forcing the electrons to travel out anode 220, through connector 222 and into the electrical load 204. An electrical connector 224 is connected to the electrical load 204. To provide for an electrical circuit, the electrical connector 224 is electrically connected to a cathode 226 of the fuel cell 202. The hydrogen supply 215 provides hydrogen to the fuel cell 202. The hydrogen supply 215 can be provided using the hydrogen source stream 122 the hydrogen production unit 100. The hydrogen supply 215 can also be provided using other sources as an option, such as a hydrogen tank 230. The hydrogen tank 230 can store hydrogen at a pressure to provide the hydrogen supply 215 if the hydrogen production unit 100 is not producing the hydrogen source stream 122, the hydrogen source stream 122 does not have a sufficient flowrate, or the hydrogen source stream 122 is not at a sufficient pressure, among other potential reasons.

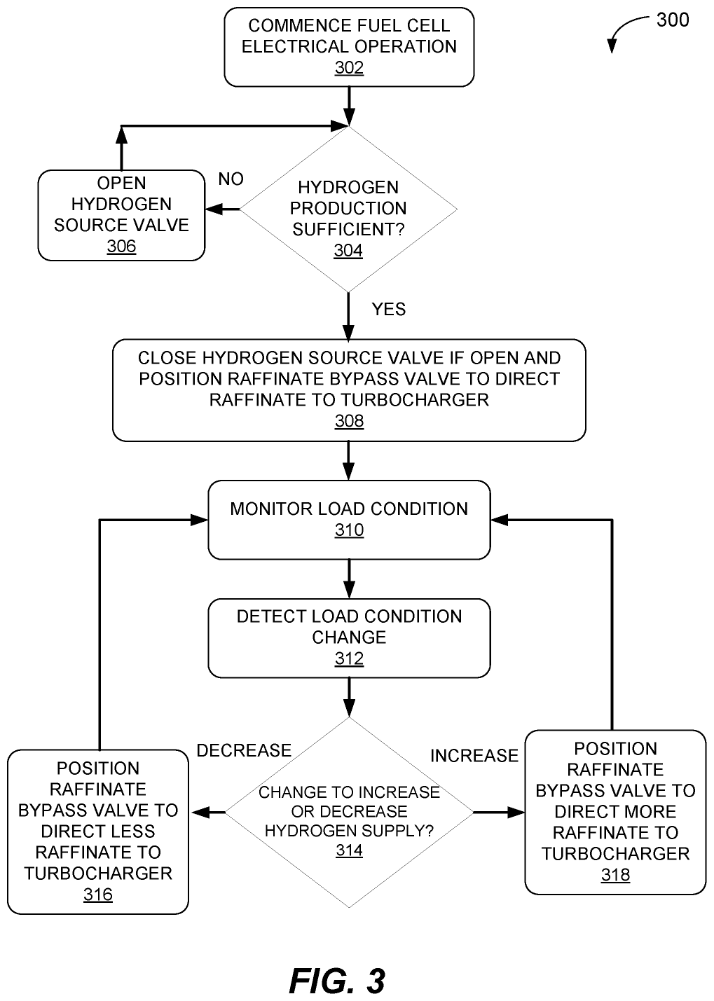

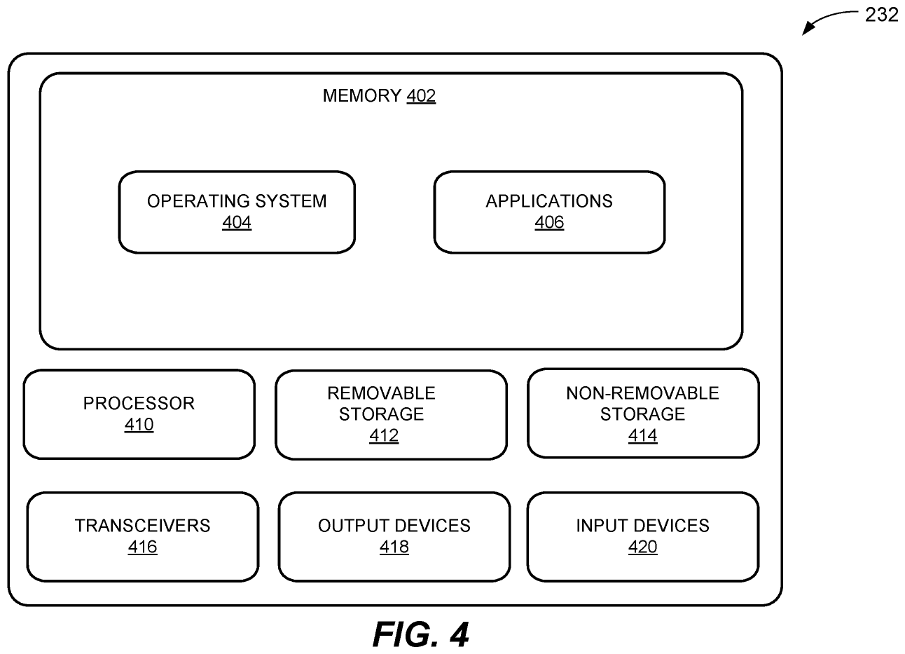

A controller 232 controls the position of the hydrogen source valve 234 by transmitting (or issuing) a source control signal 236 to open or close the hydrogen source valve 234. The controller 232 is a computer-based system that receives one or more inputs and, depending on the inputs, outputs one or more control signals to various components of the PEM fuel cell system 200, described in additional detail in FIG. 4, below. The controller 232 further controls a raffinate bypass valve 238 using bypass valve signal 240. In some examples, the flowrate of the raffinate stream 120 may be controlled to control the pressure of the hydrogen stream 118. For example, the controller 232 can change the position of the raffinate bypass valve 238 to allow more of the raffinate stream 120 to enter the turbocharger 125. The increased flowrate of the raffinate stream 120 into the turbocharger 125 can increase the rotation of the compressor 124, thus increasing the compression of the hydrogen stream 118, and in turn, increasing the pressure of the hydrogen source stream 122. In a similar manner, the controller 232 can change the position of the raffinate bypass valve 238 to allow more of the raffinate stream 120 to be bypassed into a raffinate bypass stream 242. The decreased flowrate of the raffinate stream 120 into the turbocharger 125 can decrease the rotation of the compressor 124, thus decreasing the compression of the hydrogen stream 118, and in turn, decreasing the pressure of the hydrogen source stream 122. The change of the flowrate of the raffinate stream 120 and/or the hydrogen source valve 234 may be needed as the PEM fuel cell system 200 powers up, shuts down, or changes an electrical output due to changing loading conditions of the electrical load 204, illustrated by way of example in FIG. 3.

FIG. 3 illustrates a method 300 for operating a fuel cell system, such as the PEM fuel cell system 200, using raffinate stream pressure to pressurize hydrogen, in accordance with various examples described herein. The method 300 and other processes described herein are illustrated as example flow graphs, each operation of which may represent a sequence of operations that can be implemented in hardware, machinery components, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The method 300 commences at step 302, where PEM fuel cell system 200 commences fuel cell 202 electrical production. For example, in an automobile, this may occur when the system is energized by a battery (not shown), thereby ready to commence the production of electrical power for the electrical load 204. As noted above, the electrical load 204 can be motors, pumps, controllers, electrical systems, and the like, that may be used in various machines.

At step 304, the controller 232 determines if the hydrogen production unit 100 is producing the hydrogen stream 118 at a sufficient flow rate to power the fuel cell 202 at the level of electrical power required by the electrical load 204. The hydrogen production unit 100 produces the hydrogen stream 118 by the process described in FIGS. 1 and 2. Specifically, the reformer 102 is used to reform a hydrocarbon, such as the methanol 104, into the reformer output 114, which comprises hydrogen. The reformer output 114 is separated into the raffinate stream 120 and the hydrogen stream 118 using a separator, such as the membrane separator 116. The raffinate stream 120 is in fluidic communication with and is directed into the turbine expander 126 of the turbocharger 125. The expansion of the raffinate stream 120 in the turbine expander 126 powers the compressor 124 of the turbocharger 125. The hydrogen stream 118 is in fluidic communication with and is directed into the compressor 124, where the hydrogen stream 118 is compressed to a higher pressure, resulting in the hydrogen source stream 122, which provides the hydrogen for the PEM fuel cell 202 of FIG. 2.

If at step 304 the controller 232 determines the hydrogen production unit 100 is not producing the hydrogen stream 118 at a sufficient flow rate to supply the fuel cell 202 at the power level required by the electrical load 204, the controller 232, at step 306, opens the hydrogen source valve 234 to provide hydrogen to the fuel cell 202 to commence electrical power production for the electrical load.

If at step 304 the controller 232 determines that the hydrogen production unit 100 is producing the hydrogen stream 118 at a sufficient flow rate to power the fuel cell 202, at step 308, the controller 232 closes the hydrogen source valve 234 if open and positions the raffinate bypass valve 238 to direct the raffinate stream 120 to the turbocharger 125. The raffinate stream 120 is used to compress, and therefore increase the pressure of, the hydrogen stream 118 to the pressure of the hydrogen source stream 122.

At step 310, the controller 232 monitors the load condition of the electrical load 204. The load condition can be the total amount of electrical power being used by the electrical load 204, the current charge and charge rate of any batteries (not shown) being used to provide additional or supplemental electrical power, the presence or absence of external power (not shown) that may be provided to help power electrical load 204 and the like.

At step 312, the controller 232 detects a change in the condition of the electrical load 204. The change can be for example and not by way of limitation, a change in the total amount of electrical power being used by the electrical load 204, a change in a current charge and charge rate of any batteries (not shown) being used to provide additional or supplemental electrical power, the attachment or removal of an external power source (not shown) and the like.

At step 314, the controller 232 determines if the change requires an increase or decrease in the production of hydrogen. If at step 314 the controller 232 determines that a decrease in the production of hydrogen is required, such as a reduction in the power requirement of the electrical load 204, at step 316, the controller 232 positions the raffinate bypass valve 238 to direct more of the raffinate stream 120 to the raffinate bypass stream 242, decreasing the compression of the hydrogen stream 118, reducing the amount of hydrogen available for power production by the fuel cell 202. If at step 314 the controller 232 determines that an increase in the production of hydrogen is required, such as an increase in the power requirement of the electrical load 204, at step 318, the controller positions the raffinate bypass valve 238 to direct less of the raffinate stream 120 to the raffinate bypass stream 242, increasing the compression of the hydrogen stream 118, increasing the amount of hydrogen available for power production by the fuel cell 202. It should be noted that other manners and technology may be used to change the production rate of hydrogen. For example, the flowrate of the methanol pump 108 may be changed to increase or decrease the amount of the methanol 104 feedstock entering the reformer 102. In another example, the steam supply 112 may be changed to increase or decrease the amount of the steam 110 feedstock entering the reformer 102. The method 300 from steps 316 or 318 continues to step 310, where the controller 232 monitors the load condition of the electrical load 204.

FIG. 4 depicts a component level view of the controller 232 for use with the systems and methods described herein, in accordance with one or more examples of the present disclosure. The controller 232 could be any device capable of providing the functionality associated with the systems and methods described herein. The controller 232 can comprise several components to execute the above-mentioned functions. The controller 232 may be comprised of hardware, software, or various combinations thereof. As discussed below, the controller 232 can comprise memory 402 including an operating system (OS) 404 and one or more standard applications 406. The standard applications 406 may include applications that provide for receiving and determining load conditions of the electrical load 204 to implement the method 300 of FIG. 3.

The controller 232 can also comprise one or more processors 410 and one or more of removable storage 412, non-removable storage 414, transceiver(s) 416, output device(s) 418, and input device(s) 420. In various implementations, the memory 402 can be volatile (such as random access memory (RAM)), non-volatile (such as read only memory (ROM), flash memory, etc.), or some combination of the two. The memory 402 can include data pertaining to operational ranges of combustors, hydrogen flows, and other information, and can be stored on a remote server or a cloud of servers accessible by the controller 232.

The memory 402 can also include the OS 404. The OS 404 varies depending on the manufacturer of the controller 232. The OS 404 contains the modules and software that support basic functions of the controller 232, such as scheduling tasks, executing applications, and controlling peripherals. The OS 404 can also enable the controller 232 to send and retrieve other data and perform other functions, such as transmitting (or issuing) control signals such as the source control signal 236 and the bypass valve signal 240 using the transceivers 416 and/or output devices 418, as well as, receiving load conditions using the input devices 420.

The controller 232 can also comprise one or more processors 410. In some implementations, the processor(s) 410 can be one or more central processing units (CPUs), graphics processing units (GPUs), both CPU and GPU, or any other combinations and numbers of processing units. The controller 232 may also include additional data storage devices (removable and/or non-removable) such as, for example, magnetic disks, optical disks, or tape. Such additional storage is illustrated in FIG. 4 by removable storage 412 and non-removable storage 414.

Non-transitory computer-readable media may include volatile and nonvolatile, removable and non-removable tangible, physical media implemented in technology for storage of information, such as computer readable instructions, data structures, program modules, or other data. The memory 402, removable storage 412, and non-removable storage 414 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, or any other tangible, physical medium which can be used to store the desired information, which can be accessed by the controller 232. Any such non-transitory computer-readable media may be part of the controller 232 or may be a separate database, databank, remote server, or cloud-based server.

In some implementations, the transceiver(s) 416 include any transceivers known in the art. In some examples, the transceiver(s) 416 can include wireless modem(s) to facilitate wireless connectivity with other components (e.g., between the controller 232 and a wireless modem that is a gateway to the Internet), the Internet, and/or an intranet. Specifically, the transceiver(s) 416 can include one or more transceivers that can enable the controller 232 to send and receive data. Thus, the transceiver(s) 416 can include multiple single-channel transceivers or a multi-frequency, multi-channel transceiver to enable the controller 232 to send and receive video calls, audio calls, messaging, etc. The transceiver(s) 416 can enable the controller 232 to connect to multiple networks including, but not limited to 2G, 3G, 4G, 5G, and Wi-Fi networks. The transceiver(s) 416 can also include one or more transceivers to enable the controller 232 to connect to future (e.g., 6G) networks, Internet-of-Things (IoT), machine-to machine (M2M), and other current and future networks.

The transceiver(s) 416 may also include one or more radio transceivers that perform the function of transmitting and receiving radio frequency communications via an antenna (e.g., Wi-Fi or Bluetooth®) In other examples, the transceiver(s) 416 may include wired communication components, such as a wired modem or Ethernet port, for communicating via one or more wired networks. The transceiver(s) 416 can enable the controller 232 to facilitate audio and video calls, download files, access web applications, and provide other communications associated with the systems and methods, described above.

In some implementations, the output device(s) 418 include any output devices known in the art, such as a display (e.g., a liquid crystal or thin-film transistor (TFT) display), a touchscreen, speakers, a vibrating mechanism, or a tactile feedback mechanism. Thus, the output device(s) can include a screen or display. The output device(s) 418 can also include speakers, or similar devices, to play sounds or ringtones when an audio call or video call is received. Output device(s) 418 can also include ports for one or more peripheral devices, such as headphones, peripheral speakers, or a peripheral display.

In various implementations, input device(s) 420 include any input devices known in the art. For example, the input device(s) 420 may include a camera, a microphone, or a keyboard/keypad. The input device(s) 420 can include a touch-sensitive display or a keyboard to enable users to enter data and make requests and receive responses via web applications (e.g., in a web browser), make audio and video calls, and use the standard applications 406, among other things. A touch-sensitive display or keyboard/keypad may be a standard push button alphanumeric multi-key keyboard (such as a conventional QWERTY keyboard), virtual controls on a touchscreen, or one or more other types of keys or buttons, and may also include a joystick, wheel, and/or designated navigation buttons, or the like. A touch sensitive display can act as both an input device 420 and an output device 418.

### Industrial Applicability

The present disclosure relates generally to hydrogen fuel cell systems that use a relatively higher pressure raffinate stream of a hydrogen production unit to compress a relatively lower hydrogen stream of the hydrogen production unit. Once separated into the raffinate stream 120 and the hydrogen stream 118 using a separation technology such as the membrane separator 116, the raffinate stream 120 is directed into the turbine expander 126 of a turbocharger 125. The expansion of the raffinate stream 120 rotates a shaft connected to the compressor 124 of the turbocharger 125. The hydrogen stream 118 is directed into the compressor and is compressed into a relatively higher pressure hydrogen source stream 122 used in the fuel cell 202 to produce electrical power for the electrical load 204.

Various aspects of the presently disclosed subject matter can provide various advantages. For example, using on onboard hydrogen production unit the produces hydrogen using methanol can reduce the volume of tanks needed. The pressure of the raffinate separated from the hydrogen can be used to increase the pressure of the hydrogen rather than requiring electrically powered pumps. Further, because the raffinate is expanded to compress the hydrogen, the systems that either exhaust the raffinate or store the raffinate can be built using less costly technology, as the lower pressure of the raffinate can allow for a simpler design or less costly materials than what may be required in a high pressure system.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A hydrogen production unit, comprising:
a reformer for reforming a hydrocarbon to produce an output stream comprising hydrogen and a plurality of secondary outputs;
a separator for separating the output stream into a raffinate stream at a first pressure and at least a portion of the hydrogen at a second pressure, wherein the second pressure is lower than the first pressure; and
a turbocharger comprising:
a turbine expander for receiving the raffinate stream at the first pressure and exhausting the raffinate stream at a third pressure, wherein the third pressure is lower than the first pressure, wherein an expansion of the raffinate stream rotates a shaft rotationally connected to the turbine expander; and
a compressor for receiving the portion of the hydrogen at the second pressure and compressing the portion of the hydrogen to a fourth pressure, wherein compressor is rotationally connected to the shaft.

2. The hydrogen production unit of claim 1, wherein the reformer comprises a methanol steam reformer.

3. The hydrogen production unit of claim 1, wherein the reformer comprises a partial oxidation reformer or an autothermal reformer.

4. The hydrogen production unit of claim 1, wherein the hydrocarbon comprises methanol.

5. The hydrogen production unit of claim 1, wherein the hydrocarbon comprises natural gas, light hydrocarbons, or oxygenated hydrocarbons.

6. The hydrogen production unit of claim 1, wherein the separator comprises a membrane separator.

7. The hydrogen production unit of claim 1, wherein the separator comprises a water gas shift separator, a pressure swing adsorption separator, or a partial oxidation separator.

8. The hydrogen production unit of claim 1, wherein:
the first pressure is in a range from 200 PSIG-300 PSIG;
the second pressure is in a range from 2-15 PSIG; and
the fourth pressure is in a range from 25 PSIG-90 PSIG.

9. A fuel cell system, the system comprising:
a proton exchange membrane (PEM) fuel cell configured to receive hydrogen and air to produce electrical power for an electrical load;
a hydrogen production unit for producing the hydrogen, the hydrogen production unit comprising:
a reformer for reforming a hydrocarbon to produce an output stream comprising the hydrogen and a plurality of secondary outputs;
a separator for separating the output stream into a raffinate stream at a first pressure and at least a portion of the hydrogen at a second pressure, wherein the second pressure is lower than the first pressure; and
a turbocharger comprising:
a turbine expander for receiving the raffinate stream at the first pressure and exhausting the raffinate stream at a third pressure, wherein the third pressure is lower than the first pressure, wherein an expansion of the raffinate stream rotates a shaft rotationally connected to the turbine expander; and
a compressor for receiving the portion of the hydrogen at the second pressure and compressing the portion of the hydrogen to a fourth pressure, wherein compressor is rotationally connected to the shaft.

10. The fuel cell system of claim 9, further comprising a controller comprising:
a memory storing computer-executable instructions; and
a processor in communication with the memory, the computer-executable instructions causing the processor to perform acts comprising:
transmitting a source control signal to open or close a hydrogen source valve, wherein when open, the hydrogen is provided to the PEM fuel cell by a hydrogen tank and when closed, the hydrogen is provided to the PEM fuel cell by the hydrogen production unit; and
transmitting a bypass valve signal to change a position of a raffinate bypass valve, wherein in a first position the raffinate stream is directed to a raffinate bypass stream and wherein in a second position the raffinate stream is directed to the turbine expander of the turbocharger.

11. The fuel cell system of claim 10, wherein the controller further comprises computer-executable instructions for:
determining, by the controller, that a load condition of the electrical load has increased, causing the controller to transmit the bypass valve signal to further close the raffinate bypass valve; and
determining, by the controller, that the load condition of the electrical load has decreased, causing the controller to transmit the bypass valve signal to further open the raffinate bypass valve.

12. The fuel cell system of claim 11, wherein the controller further comprises computer-executable instructions for:
determining, by the controller, that the hydrogen production unit is not producing the hydrogen at a sufficient flow rate to supply the PEM fuel cell at a power level required by the electrical load; and
upon determining that the hydrogen production unit is not producing the hydrogen at the sufficient flow rate to supply the PEM fuel cell at the power level required by the electrical load, transmitting, by the controller, the source control signal to further open the hydrogen source valve to provide the hydrogen to the PEM fuel cell from the hydrogen tank.

13. The fuel cell system of claim 12, wherein the controller further comprises computer-executable instructions for:
determining, by the controller, that the hydrogen production unit is producing the hydrogen at a sufficient flow rate to supply the PEM fuel cell at a power level required by the electrical load; and
upon determining that the hydrogen production unit is producing the hydrogen at the sufficient flow rate to supply the PEM fuel cell at the power level required by the electrical load, transmitting, by the controller, the source control signal to close the hydrogen source valve to provide the hydrogen to the PEM fuel cell from the hydrogen production unit.

14. The fuel cell system of claim 9, wherein the reformer comprises a methanol steam reformer, a partial oxidation reformer, or an autothermal reformer.

15. The fuel cell system of claim 9, wherein the hydrocarbon comprises methanol, natural gas, light hydrocarbons, or oxygenated hydrocarbons.

16. The fuel cell system of claim 9, wherein the separator comprises a membrane separator, a water gas shift separator, a pressure swing adsorption separator, or a partial oxidation separator.

17. The fuel cell system of claim 9, wherein:
the first pressure is in a range from 200 PSIG-300 PSIG;
the second pressure is in a range from 2-15 PSIG; and
the fourth pressure is in a range from 25 PSIG-90 PSIG.

18. A method of operating a fuel cell system, the method comprising:
reforming a hydrocarbon to produce a reformer output comprising hydrogen and a plurality of secondary outputs;
separating the reformer output into a hydrogen stream at a first pressure and a raffinate stream at a second pressure;
directing the hydrogen stream into a compressor of a turbocharger to compress the hydrogen stream from the first pressure to a third pressure, wherein the third pressure is higher than the first pressure; and
directing the raffinate stream into a turbine expander of the turbocharger, wherein an expansion of the raffinate stream in the turbine expander powers the compressor to compress the hydrogen stream from the first pressure to a third pressure.

19. The method of claim 18, wherein:
the first pressure is in a range from 2-15 PSIG;
the second pressure is in a range from 200 PSIG-300 PSIG; and
the third pressure is in a range from 25 PSIG-90 PSIG.

20. The method of claim 18, wherein the hydrocarbon comprises methanol, natural gas, light hydrocarbons, or oxygenated hydrocarbons.
